(19) United States
(12) Patent Application Publication
(10) Pub. No.: US 2024/0365823 A1
(43) Pub. Date: Nov. 7, 2024

(54) PROCESS FOR PRODUCING PLANT SEED MATERIAL HAVING A REDUCED CONTENT OF CYANOGENIC COMPOUNDS

(71) Applicant: Kern Tec GmbH, Herzogenburg (AT)

(72) Inventors: Sebastian Jeschko, Herzogenburg (AT); Andrea Alber, Herzogenburg (AT)

(21) Appl. No.: 18/572,910

(22) PCT Filed: Jun. 30, 2022
(86) PCT No.: PCT/EP2022/068145

§ 371 Date: Dec. 21, 2023

(30) Foreign Application Priority Data
Jun. 30, 2021 (AT) A 50545/2021

(51) Int. Cl. A23L 11/30; A23L 25/00

(52) U.S. Cl. CPC A23L 11/31; A23L 25/30

(57) ABSTRACT

A method for producing plant seed material having a reduced content of cyanogenic compounds from at least partially deoiled plant seeds, wherein the at least partially deoiled plant seeds contain cyanogenic compounds, comprising the following steps: a) providing the at least partially deoiled plant seeds, preferably in the form of a press cake, b) grinding the at least partially deoiled plant seeds, and c) depleting cyanogenic compounds in the ground plant seeds under vacuum. In another aspect, a plant seed material obtainable by this method.

### CROSS-REFERENCE TO RELATED APPLICATIONS

This application is the U.S. National Stage Application of PCT application PCT/EP2022/068145 with the filing date of Jun. 30, 2022 and claiming the benefit of priority to Austrian Patent Application A 50545/2021 with the filing date of Jun. 30, 2021, the entire disclosure of both applications is herein incorporated by reference in its entirety.

### TECHNICAL FIELD

The field of the present invention is that of processes for producing plant seed material having reduced content of cyanogenic compounds.

### BACKGROUND

Many plant seeds (especially flaxseeds, almonds or stone fruit kernels) contain cyanogenic compounds such as cyanogenic glycosides (e.g. amygdalin or linustatin). Since toxic hydrocyanic acid is produced from the cyanogenic compounds by various enzymes when the plant seeds are consumed, the plant seeds are toxic to the consumer after a certain dose and are therefore not suitable for use as food or feed unless they are processed appropriately beforehand.

A common method of detoxification (“debittering”) is decoction of the plant seeds in order to deactivate those enzymes that are ultimately responsible for the release of hydrocyanic acid from the cyanogenic compounds. However, this destroys valuable flavours.

Another known approach—and often associated with decoction—is to place the plant seeds in water for a longer period of time (usually about 24 hours) in order to promote a reaction of the cyanogenic compounds and an associated release of the hydrocyanic acid. The water containing hydrocyanic acid is then discarded. However, by boiling or washing out, aromas and proteins are destroyed or rinsed out.

Seeds “debittered” using conventional methods, under which name they are often offered, have a much lower sensory quality than before debittering.

Patent specifications DE 154733 C and DE 150277 C relate to processes for debittering almonds and other amygdalin-containing seeds. CN 1084027 A, CN 110651947 A and CN 1081328 A also disclose various processes for debittering almonds.

CN 110547391 A, CN 210988069 U, JP 2012254060 A and CN 210988068 U relate to detoxification processes for flaxseeds.

Gonzales et al. (“On the nutritive value of apricot (Prunus armeniaca) kernel. I. Comparative digestibility tests of detoxified apricot kernel and common sweet almond.”, Revista de Agroquímica y Tecnología de Alimentos, 1972, Vol 12, No 3, pages 436-443) deal with the debittering of apricot and almond kernels.

WO 1996/020716 A1 relates to the extraction of amygdalin from fruit kernels. A process for producing a food from fruit kernels is disclosed, comprising peeling the kernels, subsequently debittering the kernels by extraction with water, processing the debittered kernels into the food, and recovering amygdalin from the extract formed by debittering the kernels.

Tuncel et al. deal with the debittering of apricot kernels in two publications. In a first publication, cell digestion, cooking and soaking of bitter apricot kernels is described (Tuncel, G., M. J. R. Nout, and L. Brimer. “The effects of grinding, soaking and cooking on the degradation of amygdalin of bitter apricot seeds.” Food Chemistry 53.4 (1995): 447-451). In a second study, in addition to the particle size, the effect of heat exposure on the endogenous enzyme or the addition of exogenous enzymes is investigated (Tuncel, G., M. J. R. Nout, and L. Brimer. “Degradation of cyanogenic glycosides of bitter apricot seeds (Prunus armeniaca) by endogenous and added enzymes as affected by heat treatments and particle size.” Food chemistry 63.1 (1998): 65-69). CN 105341629 A also discloses a process for debittering apricot kernels. In El-Adawy et al. (“Biochemical studies of some non-conventional sources of proteins Part 7. Effect of detoxification the nutritional quality of apricot kernels.” Food/Nahrung 38.1 (1994): 12-20), the quality of apricot kernels is examined after a de-bittering process.

However, none of the documents described above deal with the detoxification of deoiled plant seeds (especially the detoxification of press cakes), which is a very special challenge. This is due, among other things, to the fact that these have particularly high concentrations of cyanogenic compounds or hydrocyanic acid after deoiling (especially after compressing), because these substances, as hydrophilic substances, do not pass into the oil for the most part, but remain in the deoiled residue such as the press cake.

Only Yamashita et al. (“Development of a method to remove cyanogen glycosides from flaxseed meal.” International Journal of food Science & Technology 42.1 (2007): 70-75.) concerns the detoxification of pressed flaxseeds. In the disclosed method, deoiled flaxseeds are incubated in 0.1 M sodium citrate buffer for 18 hours and then dried 24 in a continuous steam oven at 120° C. However, this process has numerous disadvantages. These include the long incubation period, the high drying temperatures and the use of the acidity regulator sodium citrate (E331). In addition, this process is not well suited for large-scale use, the flaxseed taste is also affected by the harsh process conditions and there is a loss of other valuable constituents (especially proteins).

It is therefore an object of the present invention to provide a debittering process which is intended to overcome at least one disadvantage of the state of the art. It is especially desirable that this process is as gentle as possible (so that the taste and valuable constituents of the plant seeds are preserved as much as possible) and is well suited for large-scale use.

### SUMMARY

The present invention provides a process for producing plant seed material having a reduced content of cyanogenic compounds from at least partially deoiled plant seeds, wherein the at least partially deoiled plant seeds contain cyanogenic compounds. This process comprises the following steps: a) providing the at least partially deoiled plant seeds, b) grinding the at least partially deoiled plant seeds, and c) depleting cyanogenic compounds in the ground plant seeds under vacuum. This process is particularly suitable for at least partially deoiled almonds, flaxseeds and stone fruit kernels.

In one aspect, the present invention relates to plant seed material obtainable by this process.

In a further aspect, the invention provides a plant seed material (preferably in the form of powder or granules) comprising at least partially deoiled, especially compressed, plant seeds, wherein the plant seeds are selected from almonds and stone fruit kernels, wherein the benzaldehyde content of the plant seed material with respect to its dry matter is at least 5%, preferably at least 10%, even more preferably at least 15%, especially at least 20% or even at least 25% of the content of amygdalin and prunasin in the plant seed material with respect to its dry matter.

The process according to the invention is particularly gentle and well suited for large-scale use. As a result, deoiled seeds (especially press cakes), which are conventionally produced as a waste product in the production of vegetable oils, can now be used on a large scale for new uses in the food and feed industry. This increases the yield from the harvest and thereby conserves natural resources (and the environment).

### BRIEF DESCRIPTION OF DRAWINGS

FIG. 1 shows an embodiment of the process according to the invention.

FIG. 2 shows preferred pretreatment steps.

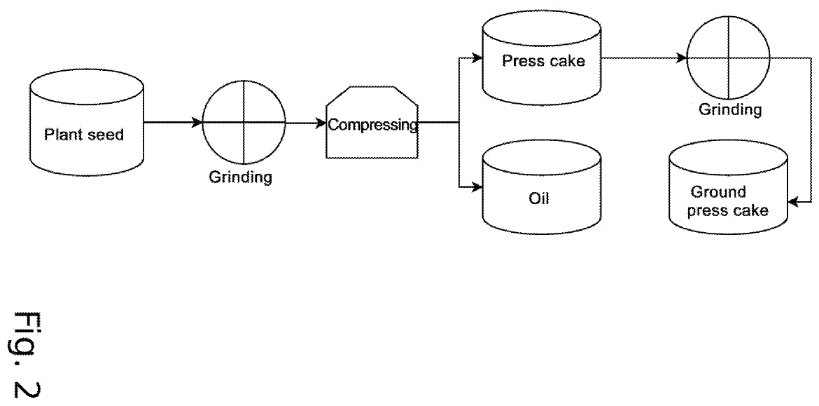

### DETAILED DESCRIPTION

The process according to the invention is based on depletion of cyanogenic compounds under vacuum. For the person skilled in the art, it is obvious that “under vacuum” in this (large-scale) context does not mean that an absolute vacuum is achieved, but only that vacuum is generated to a considerable extent. “Under vacuum” should preferably be understood to mean that a pressure falls below 600 mbar, preferably 500 mbar, more preferably 400 mbar, even more preferably 350 mbar or even 300 mbar at times (e.g. at least 15 min, preferably at least 30 min, even more preferably at least 60 min, especially at least 120 min or even at least 360 min).

The process according to the invention is suitable for the debittering of any deoiled plant seed (e.g. also of seeds that have been deoiled by means of supercritical CO2 extraction). However, particularly good results are achieved with the processing of plant seed press cakes. Therefore, in a particularly preferred embodiment in step a), the at least partially deoiled plant seeds are present in the form of a press cake. Preferably, the press cake is obtained by pressing plant seeds that have been ground before compressing.

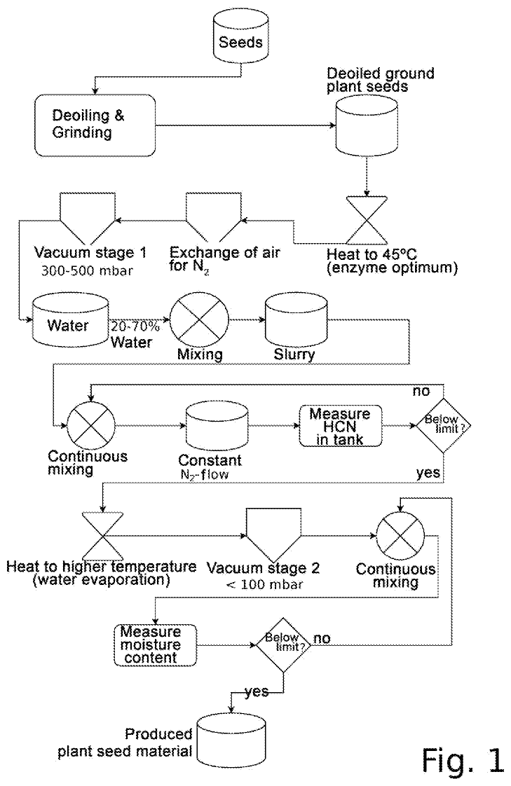

The use of two vacuum stages has proven to be particularly expedient (see also the exemplary embodiment and FIG. 1). Therefore, step c) comprises depleting cyanogenic compounds during a first vacuum stage, wherein the pressure of the first vacuum stage is higher than the pressure of the second vacuum stage. The pressure of the first vacuum stage is preferably between 300 and 500 mbar. The pressure of the second vacuum stage is preferably below 200 mbar, preferably below 150 mbar, especially below 100 mbar.

In addition or as an alternative to this, heating has proven to be useful in order to accelerate the depletion process. Consequently, in another preferred embodiment, step c) is carried out at least partially with heating (preferably so that a temperature between 30° C. and 80° C. is achieved). If several vacuum stages are used, the temperature during the first vacuum stage (preferably 30° C. to 40° C.) is expediently lower than during the second vacuum stage (preferably 40° C. to 80° C.).

Furthermore, it is advantageous for a uniform and controlled sequence if step c) is carried out at least partially with mixing.

Since the process according to the invention is particularly gentle, valuable constituents (e.g. proteins) or flavourings (e.g. benzaldehyde) are well preserved.

Therefore, in a further, particularly preferred embodiment, the total protein content of the plant seed material produced in relation to its dry matter (i.e. the total protein content in % by weight) is at least 85%, preferably at least 90%, even more preferably at least 95%, especially at least 97.5% or even at least 99% of the total protein content of the at least partially deoiled plant seeds provided in relation to their dry matter (i.e. again the total protein content in % by weight). In this context, dry matter refers to the mass without water and oil content.

With regard to almonds and stone fruit kernels, in a further, particularly preferred embodiment, the benzaldehyde content of the plant seed material with regard to its dry matter (i.e. the benzaldehyde content in % by weight) is at least 5%, preferably at least 10%, even more preferably at least 15%, especially at least 20% or even at least 25% of the content of amygdalin and prunasin in the plant seed material with regard to its dry matter (i.e. the content of amygdalin and prunasin in % by weight).

With regard to almonds and stone fruit kernels, in a further, particularly preferred embodiment, the total benzaldehyde content of the plant seed material (produced) in relation to its dry matter (i.e. the benzaldehyde content in % by weight) is at least 125%, preferably at least 150%, even more preferably at least 175%, especially at least 200% or even at least 250% of the benzaldehyde content of the at least partially deoiled plant seeds (especially of the press cake) provided in relation to their dry matter (i.e. the benzaldehyde content in % by weight); see also exemplary embodiment 2.

Furthermore, it is advantageous if the activity of the β-glucosidase amygdalin hydrolase (EC 3.2.1.117) present in the (produced) plant seed material is still so high that at least 50% by weight, preferably at least 60% by weight, even more preferably at least 70% by weight, especially at least 80% by weight or even at least 90% by weight of 100 mg of amygdalin, to which 1 g of dry matter of the plant seed material, mixed with 10 mL of water, has been added, is degraded within one hour at 40° C. (detection e.g. by HPLC), see also exemplary embodiment 3. (Amygdalin, which is already present in the plant seed material before the addition of 100 mg of amygdalin, must not be taken into account. For this purpose, a control measurement should be carried out before adding the 100 mg of amygdalin in order to determine the amount of amygdalin already present in 1 g of plant seed material.)

It is further particularly preferred if the content of cyanogenic compounds (especially cyanogenic glycosides) in the plant seed material produced or obtained is so low that less than 1000 mg/kg, preferably less than 800 mg/kg, more preferably less than 600 mg/kg, even more preferably less than 400 mg/kg or even less than 300 mg/kg, especially less than 200 mg/kg or even less than 150 mg/kg of hydrocyanic acid can be released (preferably based on the dry matter of the plant seed material).

The invention is explained in more detail below with reference to preferred, non-limiting examples and drawings.

### Example 1

Oil seeds (e.g. apricot seeds or other stone fruit kernels) are compressed to extract the oil. The press cake (conventionally a waste product) is then provided for the process according to the invention.

The press cake is ground. The ground press cake is now subjected to extraction with water under vacuum. For this purpose, the ground press cake is mixed with water in a vacuum tank at a vacuum of 300-500 mbar and a temperature of 45° C. (vacuum stage 1). With this temperature-pressure combination, the cyanide can evaporate, but not water. The process is held until the desired amount of cyanide has been extracted (or the specified cyanide limit concentration, e.g. 150 mg/kg, has been undershot). Subsequently, the vacuum and temperature are increased to evaporate the water (vacuum stage 2). This is then collected in a condenser. By separating the two phases, it can be ensured that the cyanide does not pass into the evaporated water, but can be separated. During the evaporation process, the reactor is continuously flushed with a non-reactive gas such as nitrogen to ensure better removal of HCN gas. When the desired degree of drying (e.g. 7% by weight residual moisture) has been achieved, the process is terminated. The duration of vacuum stage 1 is, for example, 2 h, and that of vacuum stage 2 is, for example, also 2 h. The plant seed material obtained after the depletion process is excellently suited for further use in the food and feed industry.

### Example 2

The plant seed material according to the invention was produced from press cakes made from stone fruit kernels (in this case sour cherries). The aroma fraction of raw material (press cake) and produced plant seed material was analysed by means of gas chromatography-mass spectrometry (GC/MS). The results are listed in Table 1 below; for better comparability, the same amount (based on dry matter) was analysed in each case.

On the basis of the quantification via the peak areas, it can be seen that the total amount of flavouring substances in relation to the dry matter has increased by a factor of 1.6 as a result of the cyanide depletion process (see last line in Table 1). In addition, the 9 relative amount of benzaldehyde (bitter almond flavour) has more than tripled (see the highlighted line on Peak #31 in Table 1). These changes explain, at least in part, the outstanding sensory qualities of the produced product.

TABLE 1
GC/MS analysis of the aroma fraction of stone fruit kernels before and
after application of the process according to the invention (i.e. raw
material compared to the plant seed material according to the invention).

| | | Before treatment | | After treatment | |
|---|---|---|---|---|---|
| Peak # | Substance name | Peak area | Percentage | Peak area | Percentage |
| 18 | 5-hepten-2-one, 6-methyl- | 35 863 | 0.02% | n.d. | n.d. |
| 19 | 1-undecanol | 36 655 | 0.03% | n.d. | n.d. |
| 42 | Acetophenone | 48 678 | 0.03% | n.d. | n.d. |
| 5 | 1-butanol, 3-methyl- | 653 043 | 0.44% | 50 474 | 0.02% |
| 26 | n.s. | 109 973 | 0.07% | 14 638 | 0.01% |
| 8 | 1-pentanol | 636 795 | 0.43% | 103 785 | 0.04% |
| | propionic acid, 3-ethoxy-, | | | | |
| | ethyl | | | | |
| 17 | ester | 71 115 | 0.05% | 14 075 | 0.01% |
| 3 | 2,6-octadien-1-ol, 2,7- | 482 851 | 0.33% | 97 399 | 0.04% |
| | dimethyl- | | | | |
| 12 | Isoterpinolene | 257 963 | 0.17% | 53 305 | 0.02% |
| 6 | n.s. | 131 273 | 0.09% | 28 166 | 0.01% |
| 7 | n.s. | 125 257 | 0.09% | 32 289 | 0.01% |
| 10 | m-cymene | 115 109 | 0.08% | 30 999 | 0.01% |
| 4 | Limonene | 1 328 090 | 0.90% | 369 635 | 0.16% |
| 2 | 3-carene | 1 789 837 | 1.21% | 523 134 | 0.22% |
| 14 | Pentadecane | 934 174 | 0.63% | 285 506 | 0.12% |
| 24 | 3-octen-2-one | 74 249 | 0.05% | 22 844 | 0.01% |
| 9 | n.s. | 101676 | 0.07% | 32 271 | 0.01% |
| 20 | Dodecanol | 57 074 | 0.04% | 18 145 | 0.01% |
| 21 | Formic acid, hexyl ester | 1 892 317 | 1.29% | 659 533 | 0.28% |
| 28 | 1-heptanol | 135 259 | 0.09% | 58 744 | 0.02% |
| 43 | 1-nonanol | 415 185 | 0.28% | 180 674 | 0.08% |
| 41 | n.s. | 136 093 | 0.09% | 62 103 | 0.03% |
| 34 | 1-octanol | 296 783 | 0.20% | 146 220 | 0.06% |
| 16 | 2-heptenal, (Z)- | 91 210 | 0.06% | 47 750 | 0.02% |
| | benzene, 1-methoxy-4- | | | | |
| | methyl-2- | | | | |
| 38 | (1-methylethyl)- | 103 677 | 0.07% | 54 858 | 0.02% |
| 44 | Benzoic acid, ethyl ester | 164 639 | 0.11% | 87 541 | 0.04% |
| 25 | 2-octenal, (E)- | 130 881 | 0.09% | 70 595 | 0.03% |
| 40 | butyric acid, 4-hydroxy- | 807 487 | 0.55% | 456 315 | 0.19% |
| 35 | 2-(2-hydroxyethoxy)ethyl | 101 523 | 0.07% | 59 216 | 0.03% |
| | acetate | | | | |
| 36 | Propanoic acid | 71 319 | 0.05% | 42 120 | 0.02% |
| 45 | Formic acid, phenylmethyl | 78 404 | 0.05% | 49 288 | 0.02% |
| | ester | | | | |
| 37 | 2,3-butanediol, isomeric | 1 870 836 | 1.27% | 1 230 948 | 52% |
| 32 | 2,3-butanediol, | 2 129 446 | 1.45% | 1 531 643 | 0.65% |
| 30 | Acetic acid + 1-hexanol, | 27 808 252 | 18.90% | 20 728 822 | 8.79% |
| | 2-ethyl | | | | |
| 46 | n.s. | 155 875 | 0.11% | 119 231 | 0.05% |
| 39 | Benzoic acid, methyl | 26 962 | 0.02% | 20 644 | 0.01% |
| | ester | | | | |
| 51 | Benzylalkohol | 47 495 809 | 32.29% | 37 374 256 | 15.85% |
| 23 | Tetraadecane | 91 044 | 0.06% | 75 418 | 0.03% |
| 22 | Nonanal | 249 820 | 0.17% | 208 728 | 0.09% |
| 58 | Valeric acid | 31 922 | 0.02% | 27 700 | 0.01% |
| 33 | Linalool | 180 554 | 0.12% | 161 284 | 0.07% |
| 13 | Acetoin | 194 142 | 0.13% | 176 041 | 0.07% |
| 1 | Hexanal | 105 210 | 0.07% | 244 536 | 0.10% |
| 11 | n.s. | 15 143 | 0.01% | 49 154 | 0.02% |
| 15 | 2-propanone, 1-hydroxy | n.d. | n.d. | 34 127 | 0.01% |
| 27 | 1-octen-3-ol | 25 387 | 0.02% | 39 008 | 0.02% |
| 29 | Furfural | 34 228 | 0.02% | 96 593 | 0.04% |
| 31 | Benzaldehyde | 51 419 405 | 34.94% | 163 677 453 | 69.38% |
| | Acetic acid, phenylmethyl | | | | |
| | ester+ | | | | |
| 47 | D-carvone | 1478 566 | 1.00% | 2 079 629 | 0.88% |
| 48 | Methyl salicylate | 23 610 | 0.02% | 55 022 | 0.02% |
| 49 | vinyl benzoate | 98 092 | 0.07% | 378 160 | 0.16% |
| | 1,3-dioxolane, 4,5- | | | | |
| | dimethy1-2- | | | | |
| 50 | phenyl- | 45 602 | 0.03% | 154 100 | 0.07% |
| 52 | phenylethyl alcohol | 466 027 | 0.32% | 1 035 402 | 0.44% |
| 53 | n.s. | 54 539 | 0.04% | 63 306 | 0.03% |
| 54 | Caprylic acid | 49 770 | 0.03% | 130 943 | 0.06% |
| 55 | 1-hydroxy, 1-phenyl-2- | 42 847 | 0.03% | 96 874 | 0.04% |
| | propanone | | | | |
| 56 | Pelargonic acid | 1 365 209 | 0.93% | 1 810 679 | 0.77% |
| 57 | Nicotinyl alcohol | n.d. | n.d. | 23 661 | 0.01% |
| 59 | Coumaric acid | 40 876 | 0.03% | 279 372 | 0.12% |
| 60 | Benzoic acid | 234 291 | 0.16% | 348 210 | 0.15% |
| | TOTAL | 147 147 902 | 100.00% | 235 902 551 | 100.00% |

n.d.—not detected, n.s.—not specified.

### Example 3

Press cakes of apricot kernels were ground and the cyanogenic compounds depleted under vacuum (first vacuum stage at 40° C., second vacuum stage at 60° C.) to obtain depleted plant seed material.

In order to determine the maintenance of enzyme activity (and thereby confirm how gentle the process according to the invention is), 1 g of the plant seed material was mixed with 100 mg of amygdalin (Sigma Aldrich/Merck) and 10 mL of water. This mixture was incubated for one hour at 40° C. After incubation, at most 30% of the added amygdalin could still be detected by HPLC. Consequently, especially the sensitive β-glucosidase amygdalin hydrolase (EC 3.2.1.117) was still very active in the plant seed material.

1. A process for producing plant seed material having reduced content of cyanogenic compounds from at least partially deoiled plant seeds, wherein the at least partially deoiled plant seeds contain cyanogenic compounds, comprising the following steps:
a) providing the at least partially deoiled plant seeds,
b) grinding the at least partially deoiled plant seeds, and
c) depleting cyanogenic compounds in the ground plant seeds under vacuum;
wherein in step a) the at least partially deoiled plant seeds are present in the form of a press cake;
wherein the total protein content of the plant seed material produced in relation to its dry matter is at least 85% of the total protein content of the at least partially deoiled plant seeds provided in relation to their dry matter.

2-16. (canceled)

17. The process according to claim 1, wherein the press cake is obtained by compressing plant seeds that have been ground before compressing.

18. The process according to claim 1, wherein step c) comprises depleting cyanogenic compounds during a first vacuum stage and a second vacuum stage, wherein the pressure of the first vacuum stage is higher than the pressure of the second vacuum stage.

19. The process according to claim 1, wherein step c) is carried out at least partially with heating.

20. The process according to claim 18, wherein step c) is carried out at least partially with heating, wherein the temperature during the first vacuum stage is lower than during the second vacuum stage.

21. The process according to claim 1, wherein step c) is carried out at least partially with mixing.

22. The process according to claim 1, wherein the total protein content of the plant seed material produced in relation to its dry matter is at least 90%, at least 95%, at least 97.5% or at least 99% of the total protein content of the at least partially deoiled plant seeds provided in relation to their dry matter.

23. The process according to claim 1, wherein the plant seeds are selected from almonds, flax seeds and stone fruit kernels.

24. The process according to claim 1, wherein the plant seeds are selected from almonds and stone fruit kernels wherein the total benzaldehyde content of the plant seed material produced in relation to its dry matter is at least 5%, at least 10%, at least 15%, at least 20% or at least 25% of the content of amygdalin and prunasin in the plant seed material produced in relation to its dry matter.

25. A plant seed material obtainable by the process according to claim 1, wherein the benzaldehyde content of the plant seed material in relation to its dry matter is at least 5% of the content of amygdalin and prunasin in the plant seed material in relation to its dry matter.

26. The plant seed material according to claim 25, wherein the benzaldehyde content of the plant seed material with respect to its dry matter is at least 10%, at least 15%, at least 20% or at least 25% of the content of amygdalin and prunasin in the plant seed material with respect to its dry matter.

27. The plant seed material according to claim 25, wherein the content of cyanogenic compounds in the plant seed material is so low that, with respect to the total mass of the plant seed material, less than 1000 mg/kg, less than 800 mg/kg, less than 600 mg/kg, less than 400 mg/kg, less than 300 mg/kg, less than 200 mg/kg or less than 150 mg/kg of hydrocyanic acid can be released.

28. A plant seed material in the form of powder or granules comprising compressed plant seeds, wherein the plant seeds are selected from almonds and stone fruit kernels, wherein the benzaldehyde content of the plant seed material with respect to its dry matter is at least 5%, at least 10%, at least 15%, at least 20% or at least 25% of the content of amygdalin and prunasin in the plant seed material with respect to its dry matter.

29. The plant seed material according to claim 28, wherein the content of cyanogenic compounds in the plant seed material is so low that, with respect to the total mass of the plant seed material, less than 1000 mg/kg, less than 800 mg/kg, less than 600 mg/kg, less than 400 mg/kg, less than 300 mg/kg, less than 200 mg/kg or less than 150 mg/kg of hydrocyanic acid can be released.

30. The plant seed material according to claim 27, wherein the activity of the β-glucosidase amygdalin hydrolase (EC 3.2.1.117) present in it is still so high that at least 50%, 60%, 70%, 80% or 90% by weight of 100 mg of amygdalin, to which 1 g of dry matter of the plant seed material, mixed with 10 mL of water, has been added, is degraded within one hour at 40° C.
